(19) United States
(12) Patent Application Publication
(10) Pub. No.: US 2026/0313402 A1
(43) Pub. Date: Oct. 8, 2026

(54) INFORMATION PROCESSING APPARATUS, INFORMATION PROCESSING METHOD, INFORMATION PROCESSING SYSTEM, COMPUTER-READABLE MEDIUM, AND GENERATION METHOD

(71) Applicant: NEC Corporation, Minato-ku, Tokyo (JP)

(72) Inventors: Takeo ONISHI, Tokyo (JP); Eiji TAKAHASHI, Tokyo (JP); Yoshiaki NISHIKAWA, Tokyo (JP); Kenji KAWAGUCHI, Tokyo (JP); Yoshinori WATANABE, Tokyo (JP); Masayuki UEDA, Tokyo (JP); Hideki KOZUKA, Tokyo (JP); Rumi MATSUMURA, Tokyo (JP); Katsunori DATE, Tokyo (JP)

(73) Assignee: NEC Corporation, Minato-ku, Tokyo (JP)

(21) Appl. No.: 18/993,063

(22) PCT Filed: Aug. 18, 2022
(86) PCT No.: PCT/JP2022/031253

§ 371 Date: Jan. 10, 2025

(51) Int. Cl. H04W 24/08

(52) U.S. Cl. CPC H04W 24/08

(57) ABSTRACT

There is provided an information processing apparatus (20) including an acquisition unit (21) configured to acquire a value indicating a wireless state with each of a plurality of user terminals located in the same base station; a pre-processing unit (22) configured to add the value indicating the wireless state of each user terminal acquired by the acquisition unit; and a specifying unit (23) configured to specify setting of wireless communication for a specific user terminal on the basis of an addition value calculated by the pre-processing unit and a value indicating the wireless state of the specific user terminal included in the plurality of user terminals acquired by the acquisition unit.

### TECHNICAL FIELD

The present disclosure relates to an information processing apparatus, an information processing method, an information processing system, a computer-readable medium, and a generation method.

### BACKGROUND ART

It has been studied to determine various parameters related to wireless communication between a base station and a user terminal by using machine learning (AI/ML, Artificial Intelligence/Machine Learning) (for example, Patent Literature 1).

### CITATION LIST

### Patent Literature

Patent Literature 1: Japanese Unexamined Patent Application Publication No. 2022-105306

### SUMMARY OF INVENTION

### Technical Problem

However, in the technique described in Patent Literature 1, for example, various parameters related to wireless communication between the base station and the user terminal may not be appropriately determined.

An object of the present disclosure is to provide a technique capable of appropriately determining various parameters related to wireless communication between a base station and a user terminal in view of the above-described problems.

### Solution to Problem

In a first aspect according to the present disclosure, there is provided an information processing apparatus including an acquisition unit configured to acquire a value indicating a wireless state with each of a plurality of user terminals located in the same base station; a pre-processing unit configured to add the value indicating the wireless state of each user terminal acquired by the acquisition unit; and a specifying unit configured to specify setting of wireless communication for a specific user terminal on the basis of an addition value calculated by the pre-processing unit and a value indicating the wireless state of the specific user terminal included in the plurality of user terminals acquired by the acquisition unit.

In addition, in a second aspect according to the present disclosure, there is provided an information processing method of executing processing including acquiring a value indicating a wireless state with each of a plurality of user terminals located in the same base station; adding the acquired value indicating the wireless state of each user terminal; and specifying setting of wireless communication for a specific user terminal on the basis of an addition value and a value indicating the wireless state of the specific user terminal included in the plurality of user terminals.

In addition, in a third aspect according to the present disclosure, there is provided an information processing system including a specific user terminal; and an information processing apparatus, in which the information processing apparatus includes an acquisition unit configured to acquire a value indicating a wireless state with each of a plurality of user terminals located in the same base station, a pre-processing unit configured to add the value indicating the wireless state of each user terminal acquired by the acquisition unit, and a specifying unit configured to specify setting of wireless communication for the specific user terminal on the basis of an addition value calculated by the pre-processing unit and a value indicating the wireless state of the specific user terminal included in the plurality of user terminals acquired by the acquisition unit.

In addition, in a fourth aspect according to the present disclosure, there is provided a non-transitory computer-readable medium in which a program of causing a computer to execute processing is stored, the processing including acquiring a value indicating a wireless state with each of a plurality of user terminals located in the same base station; adding the acquired value indicating the wireless state of each user terminal; and specifying setting of wireless communication for a specific user terminal on the basis of an addition value and a value indicating the wireless state of the specific user terminal included in the plurality of user terminals.

In addition, in a fifth aspect according to the present disclosure, there is provided an information processing apparatus including an acquisition unit configured to acquire a data set in which a value indicating a wireless state with each of a first plurality of user terminals located in a first base station is associated with information regarding setting of wireless communication for a first user terminal included in the first plurality of user terminals; a pre-processing unit configured to add the value indicating the wireless state of each user terminal acquired by the acquisition unit; and a generation unit configured to generate a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on the basis of the addition value calculated by the pre-processing unit, the value indicating the wireless state of the first user terminal acquired by the acquisition unit, and the information regarding the setting of the wireless communication for the first user terminal acquired by the acquisition unit.

In addition, in a sixth aspect according to the present disclosure, there is provided a generation method including acquiring a data set in which a value indicating a wireless state with each of a first plurality of user terminals located in a first base station is associated with information regarding setting of wireless communication for a first user terminal included in the first plurality of user terminals; adding the acquired value indicating the wireless state of each user terminal; and generating a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on the basis of the addition value, the value indicating the wireless state of the first user terminal, and the information regarding the setting of the wireless communication for the first user terminal.

In addition, in a seventh aspect according to the present disclosure, there is provided a non-transitory computer-readable medium in which a program of causing a computer to execute processing is stored, the processing including acquiring a data set in which a value indicating a wireless state with each of a first plurality of user terminals located in a first base station is associated with information regarding setting of wireless communication for a first user terminal included in the first plurality of user terminals; adding the acquired value indicating the wireless state of each user terminal; and generating a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on the basis of the addition value, the value indicating the wireless state of the first user terminal, and the information regarding the setting of the wireless communication for the first user terminal.

### Advantageous Effects of Invention

According to one aspect, various parameters related to wireless communication between a base station and a user terminal can be appropriately determined.

### BRIEF DESCRIPTION OF DRAWINGS

FIG. 1 is a diagram illustrating an example of a configuration of an information processing apparatus that performs learning processing according to an example embodiment.

FIG. 2 is a diagram illustrating an example of a configuration of an information processing apparatus that performs specifying processing according to an example embodiment.

FIG. 3 is a diagram illustrating an example of a configuration of an information processing system according to an example embodiment.

FIG. 4 is a diagram illustrating a hardware configuration example of each information processing apparatus according to an example embodiment.

FIG. 5 is a flowchart illustrating an example of learning processing of an information processing apparatus according to an example embodiment.

FIG. 6 is a diagram illustrating an example of a wireless communication DB according to an example embodiment.

FIG. 7 is a diagram illustrating an example of a pre-processed DB according to an example embodiment.

FIG. 8 is a flowchart illustrating an example of specifying processing of an information processing apparatus according to an example embodiment.

### EXAMPLE EMBODIMENT

The principles of the present disclosure will be described with reference to several example embodiments. It is to be understood that the example embodiments have been described for purposes of illustration only and will aid those skilled in the art in understanding and carrying out the present disclosure without suggesting limitations on the scope of the present disclosure. The disclosure described in the present specification is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings.

### First Example Embodiment

### Configuration

### Configuration of Information Processing Apparatus 10 that Performs Learning Processing

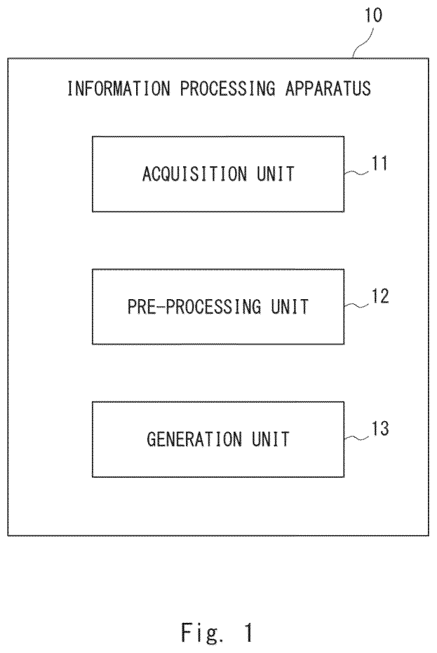

A configuration of an information processing apparatus 10 that performs learning processing, according to an example embodiment will be described with reference to FIG. 1. FIG. 1 is a diagram illustrating an example of a configuration of the information processing apparatus 10 that performs learning processing according to the example embodiment. The information processing apparatus 10 includes an acquisition unit 11, a pre-processing unit 12, and a generation unit 13. These units may be implemented by cooperation of one or more programs installed in the information processing apparatus 10 and hardware such as a processor and a memory of the information processing apparatus 10.

The acquisition unit 11 acquires a data set in which a value indicating a wireless state with each of a first plurality of user terminals located in a first base station is associated with information regarding setting of wireless communication for a first user terminal included in the first plurality of user terminals. The pre-processing unit 12 adds the value indicating the wireless state of each user terminal acquired by the acquisition unit 11. Note that the value indicating the wireless state may be, for example, a vector, an array, or a tensor including a plurality of values.

The generation unit 13 generates a function (model) having an addition value calculated by the pre-processing unit 12 and the value indicating the wireless state of the first user terminal acquired by the acquisition unit 11 as explanatory variables and the information regarding the setting of the wireless communication for the first user terminal acquired by the acquisition unit 11 as an objective variable. As a result, the generation unit 13 generates a model that specifies information regarding setting of the wireless communication for a second user terminal according to an addition value of a value indicating a wireless state with each of a second plurality of user terminals located in a second base station and the value indicating the wireless state of the second user terminal included in the second plurality of user terminals.

### Configuration of Information Processing Apparatus 20 that Performs Specifying (Determination, Inference, Estimation, Expectation, Prediction)

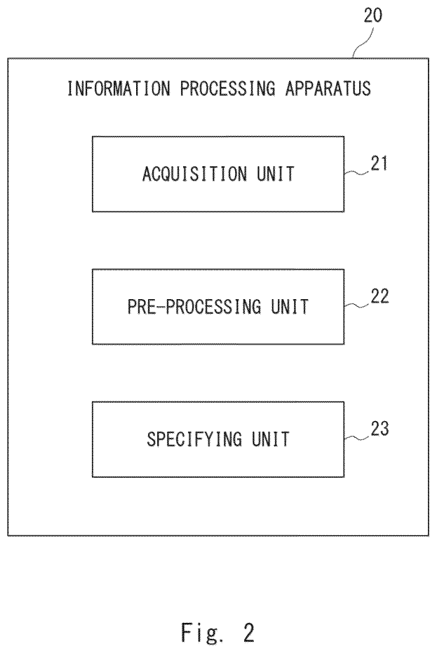

Next, a configuration of an information processing apparatus 20 that performs the specifying processing according to the example embodiment will be described with reference to FIG. 2. FIG. 2 is a diagram illustrating an example of a configuration of the information processing apparatus 20 that performs specifying processing according to the example embodiment. The information processing apparatus 20 includes an acquisition unit 21, a pre-processing unit 22, and a specifying unit 23. These units may be implemented by cooperation of one or more programs installed in the information processing apparatus 20 and hardware such as a processor and a memory of the information processing apparatus 20.

The acquisition unit 21 acquires a value indicating a wireless state with each of a plurality of user terminals located in the same base station. The pre-processing unit 22 adds the value indicating the wireless state of each user terminal acquired by the acquisition unit 21. The specifying unit 23 specifies the setting of the wireless communication for a specific user terminal on the basis of an addition value calculated by the pre-processing unit 22 and a value indicating a wireless state of a specific user terminal included in the plurality of user terminals acquired by the acquisition unit 21.

### Second Example Embodiment

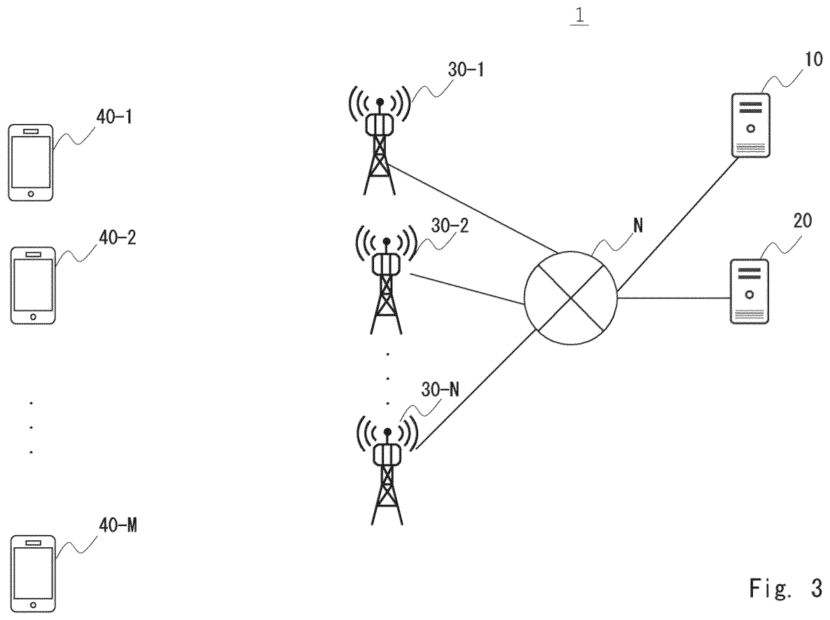

Next, a configuration of an information processing system 1 according to an example embodiment will be described with reference to FIG. 3.

### System Configuration

FIG. 3 is a diagram illustrating an example of a configuration of the information processing system 1 according to the example embodiment. In the example of FIG. 3, the information processing system 1 includes the information processing apparatus 10 and the information processing apparatus 20. Note that the number of information processing apparatuses 10 and the number of information processing apparatuses 20 are not limited to those in the example of FIG. 3. In addition, the information processing system 1 includes a base station 30-1, a base station 30-2, . . . , and a base station 30-N (hereinafter, simply referred to as a “base station 30” in a case where there is no need to distinguish the base stations). Note that N may be any natural number. In addition, the information processing system 1 includes a user terminal 40-1, a user terminal 40-2, . . . , and a user terminal 40-M (hereinafter, simply referred to as a “user terminal 40” in a case where there is no need to distinguish the user terminals). Note that M may be any natural number.

In the example of FIG. 3, the information processing apparatus 10, the information processing apparatus 20, and the base station 30 are connected to be able to communicate with each other via a network N. Examples of the network N include a backhaul link, a core network, a local area network (LAN), a bus, and the like.

In addition, the base station 30 and the user terminal 40 are connected to be able to communicate by wireless communication (access link) of a mobile communication system. Examples of the mobile communication system include a fifth generation mobile communication system (5G), a sixth generation mobile communication system (6G, Beyond 5G), a fourth generation mobile communication system (4G), a third generation mobile communication system (3G), a wireless LAN, and the like.

The information processing system 1 may conform to, for example, a specification of Open Radio Access Network (O-RAN) Alliance. In this case, the information processing apparatus 10 and the information processing apparatus 20 may be included in a radio access network (RAN) intelligent controller (RIC). Note that the RIC may be, for example, a controller that manages/controls nodes such as a Radio Unit (RU), a Distributed Unit (DU), and a Central Unit (CU, aggregation base station), constituting the RAN using artificial intelligence/machine learning (AI/ML).

For example, the RIC may provide wireless connection of different required quality for each user (for example, each terminal, each bearer, or each session). In addition, the RIC may optimize wireless connection control (beamforming or the like) by, for example, processing resources (for example, a wireless resource such as a physical resource block (PRB)) of the RAN or multiple antennas (multi input and multi output (MIMO)). In addition, the RIC may optimize communication for each network slice (virtualized set of network resources), for example.

In this case, the information processing apparatus 10 that performs learning processing may be included in, for example, a non real-time RIC (Non-RT-RIC) arranged together with or in the vicinity of a central cloud station such as an operation support system (OSS). In addition, the information processing apparatus 20 that performs inference processing may be included in, for example, a near realtime RIC (Near-RT RIC) arranged together with or in the vicinity of a node such as a CU.

The base station 30 is a base station that includes nodes such as an RU, a DU, and a CU and provides an access link to the user terminal 40. The base station 30 may be configured as an integrated apparatus including an RU, a DU, and a CU in the same housing.

In addition, the base station 30 may be, for example, a virtualized base station. In this case, for example, the base station 30 may be configured as a separate apparatus including at least one of an RU, a DU, and a CU in another housing. In this case, at least one function of the DU and the CU may be realized by a server (computer) installed near the RU or a program (software) operating on a server on a cloud. Note that the base station 30 may be referred to as, for example, a next Generation NodeB (gNodeB, gNB), an evolved NodeB (eNodeB, eNB), or the like.

The user terminal 40 may be, for example, a smartphone, a tablet, an Internet of Things (IoT) device, a mobile object (for example, a vehicle, a drone, or an airplane) having a wireless communication function, a robot (for example, a factory robot and a home robot) having a wireless communication function, or the like. The user terminal 40 may be referred to as, for example, user equipment (UE) or the like.

### Hardware Configuration

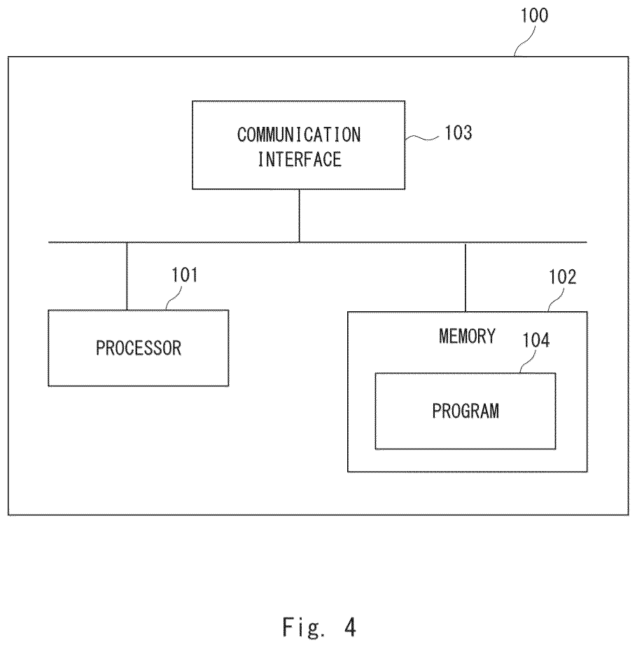

FIG. 4 is a diagram illustrating a hardware configuration example of the information processing apparatus 10 and the information processing apparatus 20 according to the example embodiment. Hereinafter, the information processing apparatus 10 will be described as an example, but the hardware configuration of the information processing apparatus 20 may be similar to that of the information processing apparatus 10. In the example of FIG. 4, the information processing apparatus 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

When the program 104 is executed by the cooperation of the processor 101, the memory 102, and the like, at least a part of the processing according to the example embodiment of the present disclosure is performed by the computer 100. The memory 102 may be of any type. The memory 102 may be a non-transitory computer-readable storage medium, as a non-limiting example. In addition, the memory 102 may also be implemented using any suitable data storage technique such as a semiconductor-based memory device, a magnetic memory device and system, an optical memory device and system, a fixed memory, or a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. The functions of the program module may be combined or divided between the program modules as desired in various example embodiments. A machine-executable instruction of the program module can be executed in a local or distributed device. In the distributed device, the program modules can be located on both local and remote storage media.

Program codes for executing the methods of the present disclosure may be written in any combination of one or more programming languages. These program codes are provided to a processor or controller of a general purpose computer, a dedicated computer, or other programmable data processing apparatuses. When the program code is executed by the processor or controller, the functions/operations in the flowcharts and/or the implemented block diagrams are performed. The program code is executed entirely on a machine, partially on the machine as a stand-alone software package, partially on the machine and partially on a remote machine, or entirely on the remote machine or server.

The program can be stored and supplied to the computer using various types of non-transitory computer-readable media. The non-transitory computer-readable medium includes various types of tangible recording media. Examples of the non-transitory computer-readable medium include a magnetic recording medium, a magneto-optical recording medium, an optical disc medium, and a semiconductor memory. Examples of the magnetic recording medium include a flexible disk, a magnetic tape, and a hard disk drive. Examples of the magneto-optical recording medium include a magneto-optical disk. Examples of the optical disc medium include a Blu-ray disc, a compact disc (CD)-read only memory (ROM), a CD-recordable (R), and a CD-rewritable (RW). Examples of the semiconductor memory include a solid state drive, a mask ROM, a programmable ROM (PROM), an erasable PROM (EPROM), a flash ROM, and a random access memory (RAM). In addition, the program may be supplied to the computer using various types of transitory computer-readable media. Examples of the transitory computer-readable medium include electrical signals, optical signals, and electromagnetic waves. The transitory computer-readable medium can supply the programs to the computer via a wired communication path such as an electric wire and an optical fiber or a wireless communication path.

### Processing

### Learning Processing

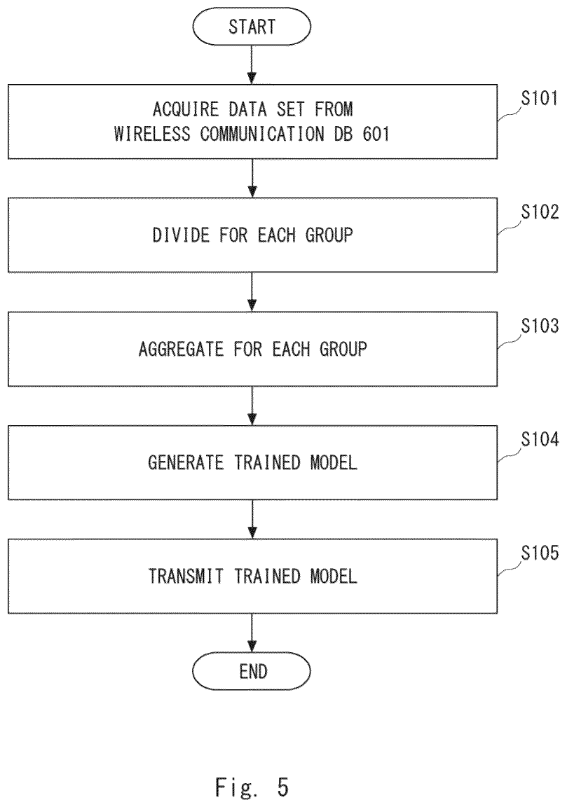

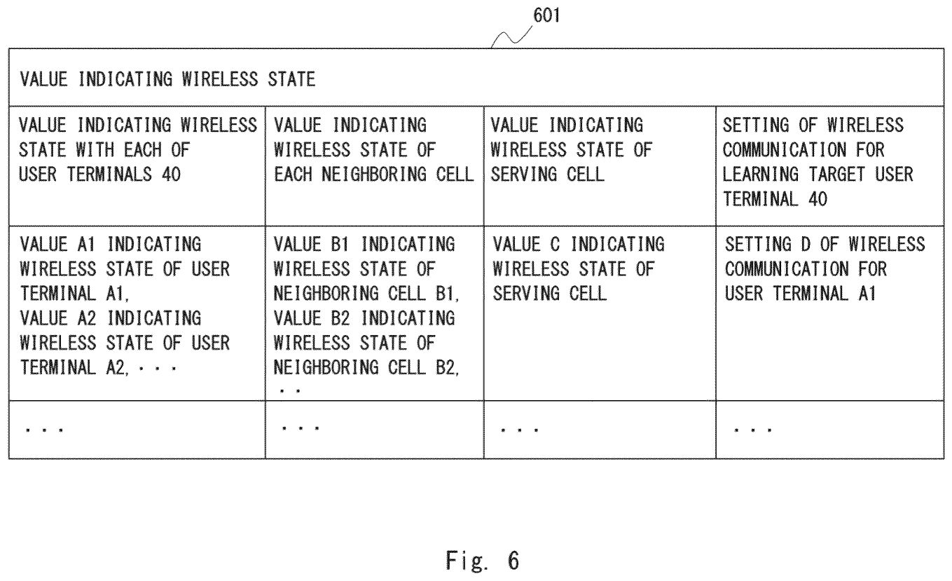

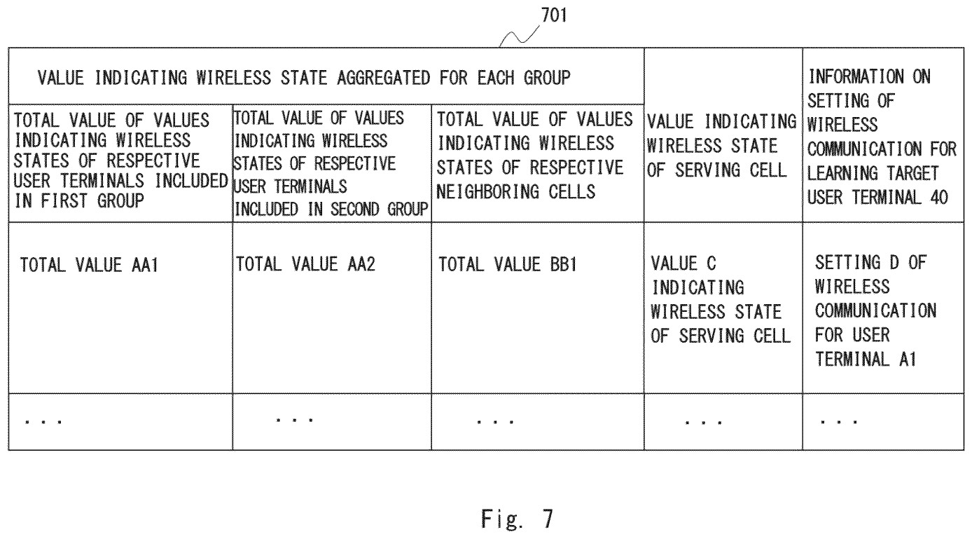

Next, an example of learning processing (processing of generating a trained model) of the information processing apparatus 10 according to the example embodiment will be described with reference to FIGS. 5 to 8. FIG. 5 is a flowchart illustrating an example of the learning processing of the information processing apparatus 10 according to the example embodiment. FIG. 6 is a diagram illustrating an example of a wireless communication database (DB) 601 according to the example embodiment. FIG. 7 is a diagram illustrating an example of a pre-processed DB 401 according to the example embodiment. The processing of FIG. 5 may be executed, for example, when instructed by an administrator of the information processing apparatus 10 or at a predetermined timing such as periodically. Note that the processing of FIG. 5 may be executed for each of the uplink and the downlink, for example. In this case, the trained model for the uplink is generated and distributed by the processing of FIG. 5 for the uplink, and the trained model for the downlink is generated and distributed by the processing of FIG. 5 for the downlink.

In step S101, the acquisition unit 11 acquires a data set for machine learning from the wireless communication DB 601. The wireless communication DB 601 may be recorded in a storage device inside the information processing apparatus 10 or may be recorded in a storage device outside the information processing apparatus 10.

In the example of FIG. 6, the wireless communication DB 601 includes a data set (set) of a combination (record) of a value indicating a wireless state (state of wireless communication) and information on setting of the wireless communication for a certain user terminal 40 (hereinafter, also appropriately referred to as a “learning target user terminal 40”). In the example of FIG. 6, the value indicating the wireless state includes a value indicating the wireless state of one base station 30 (first base station 30) as a serving cell with each of the plurality of user terminals 40. Note that the plurality of user terminals 40 include the learning target user terminal 40. In addition, the value indicating the wireless state includes a value indicating the wireless state of each neighboring cell and a value indicating the wireless state of the serving cell. The value indicating the wireless state may be information acquired (measured, calculated) at a certain time point by each base station 30. Note that the serving cell may be the base station 30 in which the learning target user terminal 40 is located (position registration). In addition, the neighboring cell (neighbor cell) may be, for example, the base station 30 that may interfere with the serving cell.

The value indicating the wireless state of the user terminal 40 may be a vector value having a plurality of elements. The value indicating the wireless state of the user terminal 40 may include, for example, at least one of information indicating values of various indexes such as transition of a channel quality indicator (CQI) in the user terminal 40, transition of a retransmission rate for each modulation and coding scheme (MCS), a PRB utilization rate, a radio wave quality index (for example, reference signal received power (RSRP), reference signal received quality (RSRQ), and the like.) of the neighboring cell, and a transmission data amount. The transition of the CQI and the transition of the retransmission rate for each MCS may be, for example, time-series data at a specific time interval (for example, several tens of milliseconds to several hundreds of milliseconds). The value indicating the wireless state of the user terminal 40 may include a value calculated as a feature amount on the basis of at least one of values of various indexes such as transition of CQI, transition of a retransmission rate for each MCS, a PRB utilization rate, a radio wave quality index of the neighboring cell, and a transmission data amount, and a trained model such as a neural network (NN). In this case, the trained model may be generated by supervised learning, or may be generated by unsupervised learning such as an auto encoder for dimension reduction, for example.

The value indicating the wireless state of the neighboring cell may include, for example, information indicating a physical resource block (PRB) utilization rate in the base station 30 which is the neighboring cell. The value indicating the wireless state of the serving cell may include, for example, information indicating at least one of a PRB utilization rate in the base station 30 which is the serving cell and the number of active UEs (the number of user terminals 40 in communication using the serving cell).

The information on the setting of the wireless communication for the learning target user terminal 40 is a ground truth label (ground truth value) in the record for machine learning. For example, the information on the setting of the wireless communication for the learning target user terminal 40 may be determined to be the setting information that actually satisfies the requirement (communication requirement) of the wireless communication quality such as a delay on the basis of the log data of the wireless communication in at least one of the learning target user terminal 40 and the serving cell base station 30. In this case, the log data may include information indicating a queuing amount and a retransmission rate of a buffer in at least one of the learning target user terminal 40 and the serving cell base station 30. In addition, an index value indicating whether the setting is good or bad may be calculated on the basis of the log data, and learning (reinforcement learning) may be performed so as to select an action for which the index value is increased. In this case, the index value may give a larger value as the queuing amount or the retransmission rate is smaller, for example. In addition, the information on the setting of the wireless communication for the learning target user terminal 40 may be determined to be a setting that theoretically satisfies the requirement of wireless communication quality such as a delay on the basis of, for example, a simulation or the like. In addition, the information on the setting of the wireless communication for the learning target user terminal 40 may be manually determined (granted, registered, set) by, for example, the administrator or the like of the information processing apparatus 10.

The setting of the wireless communication for the learning target user terminal 40 may include, for example, a setting value of an MCS indicating the number of useful bits that can be transmitted in one symbol. In this case, the setting value may be, for example, an offset value with respect to a normally used value. In this case, for example, the MCS Index 15 is usually used, and in a case where the set offset value is 3, the MCS Index 12 (=15−3) is set.

In addition, the setting of the wireless communication for the learning target user terminal 40 may include, for example, a parameter of a scheduler of the wireless communication indicating at least one of the ratio of the amount of wireless resources and the amount of allocation of the transmission opportunities. In addition, the setting of the wireless communication for the learning target user terminal 40 may include, for example, setting of an upper limit of the spatial multiplexing number of multiple-input and multiple-output (MIMO).

Subsequently, the pre-processing unit 12 divides (classifies) values of at least some data items included in each record for machine learning acquired by the acquisition unit 11, for each group (step S102).

### Division into Groups of User Terminals 40

Here, for example, the pre-processing unit 12 may set a value group indicating the wireless state of each of the plurality of user terminals 40 as one group, or may divide (classify) the value group for each group of the user terminals 40. Specifically, in the case of the division for each group of the user terminals 40, the pre-processing unit 12 may specify the group to which each user terminal 40 belongs according to, for example, at least one of the communication requirement of the user terminal 40, the magnitude of the wireless quality fluctuation, and the received radio field intensity (hereinafter, also appropriately referred to as “communication requirement and the like”).

The communication requirements may include, for example, requirements such as a delay, a throughput, and a packet loss rate. In addition, the communication requirement may be determined (identified, estimated) on the basis of, for example, the type of application with which the user terminal 40 performs communication. In this case, the type of application may include, for example, a type according to the use of wireless communication in the user terminal 40, such as real-time video, real-time audio, non-real-time video, non-real-time audio, notification of state information of an IoT device or the like, and control of the IoT device or the like.

In addition, the communication requirement may be determined (identified, estimated) on the basis of, for example, a 5G quality of service (QoS) identifier (5QI). Note that the 5QI may include, for example, values indicating QoS characteristics such as a priority level, a packet delay, and a packet error rate.

The magnitude of the wireless quality fluctuation may be, for example, dispersion of an index such as a CQI indicating the quality of wireless communication. The received radio field intensity may be, for example, an average value of received radio field intensities at the user terminal 40.

The information such as the communication requirement may be acquired from, for example, an external application server. In this case, the information processing apparatus 10 may acquire information from the external application server via the Internet or the like, for example. In addition, the external application server may be included in the Non-RT-RIC or the Near-RT RIC.

In addition, the information such as the communication requirement may be analyzed on the basis of the communication packet of the user terminal 40. In this case, for example, the type of the application of the user terminal 40 that performs periodic communication may be determined to be notification of state information of an IoT device or the like. In addition, the communication requirement may be determined on the basis of the communication cycle. In addition, the type of the application may be determined to be a real-time video or the like on the basis of the header of the communication packet. In addition, the information such as the communication requirement may be notified from the user terminal 40.

### Division into Groups of Neighboring Cells

In addition, for example, the pre-processing unit 12 may set a value group indicating the wireless state of each neighboring cell as one group, or may divide (classify) the value group for each group of neighboring cells. Specifically, in the case of division for each group of neighboring cells, the pre-processing unit 12 may specify the group to which each neighboring cell belongs according to, for example, the magnitude of interference with the serving cell.

Subsequently, the pre-processing unit 12 of the information processing apparatus 10 performs preprocessing of aggregating a plurality of values of data items, which are divided for each group, for each group, and records a data set for machine learning after the preprocessing in a pre-processed DB 701 (step S103). Note that the pre-processed DB 701 may be recorded in a storage device inside the information processing apparatus 10 or may be recorded in a storage device outside the information processing apparatus 10.

Here, for example, the pre-processing unit 12 may aggregate the data included in each record by adding (for example, total) the data of each group divided in step S102 for each group. In the example of FIG. 7, the pre-processed DB 701 includes a data set (set) of a record including a combination of a value indicating a wireless state aggregated for each group, a value indicating a wireless state of a serving cell, and information on the setting of the wireless communication for the learning target user terminal 40.

In the example of FIG. 7, the value indicating the wireless state aggregated for each group includes a total value of values indicating the wireless states of respective user terminals 40 included in a first group, a total value of values indicating the wireless states of respective user terminals 40 included in a second group, and a total value of values indicating the wireless states of respective neighboring cells.

In the example of FIG. 7, the user terminals 40 are divided into the first group and the second group, and neighboring cells are grouped into one group. The first group may be a group having a relatively large influence (compared to the second group) on the setting of the wireless communication for the learning target user terminal 40. In this case, the first group may be, for example, a group with a relatively strict communication requirement or the like (for example, at least one of low latency and high throughput is required). In addition, the first group may be, for example, a group in which the magnitude of the wireless quality fluctuation is relatively large. In addition, the first group may be, for example, a group having relatively low radio field intensity. In addition, the first group may be, for example, a group of the user terminals 40 in which a higher score is equal to or greater than a threshold as the communication requirement or the like is relatively strict, the magnitude of the wireless quality fluctuation is larger, and the radio field intensity is smaller.

The pre-processing unit 12 may set an addition value of values indicating the wireless states with a first granularity of the user terminals 40 included in the first group, as a value indicating the wireless state aggregated into the first group. In addition, the pre-processing unit 12 may set an addition value of values indicating the wireless states with a second granularity, which is coarser than the first granularity, of the user terminals included in the second group, as a value indicating the wireless state aggregated into the second group. Here, the coarse granularity includes, for example, that the number of elements (dimensions) of data is small. In this case, the pre-processing unit 12 may set time-series data obtained by adding the value indicating the wireless state of each user terminal 40 included in the first group for each time point, as a value indicating the wireless state aggregated in the first group. In this case, for example, the pre-processing unit 12 may calculate at least one of the time-series data obtained by adding a value at each time point of the CQI of each user terminal 40 included in the first group, for each time point and the time-series data obtained by adding a value at each time point of the retransmission rate for each MCS, for each time point.

In addition, the pre-processing unit 12 may set an addition value of the average value of the values indicating the wireless states of the user terminals included in the second group, as a value indicating the wireless state aggregated into the second group. In this case, for example, the pre-processing unit 12 may calculate at least one of a value obtained by adding an average value of the values at individual time points of the CQI of each user terminal 40 included in the second group and a value obtained by adding an average value of the values at individual time points of the retransmission rate for each MCS. As a result, the learning processing can be speeded up.

Subsequently, the generation unit 13 of the information processing apparatus 10 generates a trained model by performing learning on the basis of the data set for machine learning after preprocessing recorded in the pre-processed DB 701 (step S104). Here, the generation unit 13 may perform supervised learning for at least one of the classification problem and the regression problem. In this case, the generation unit 13 performs machine learning in which the value indicating the wireless state aggregated for each group and the value indicating the wireless state of the serving cell are set as the explanatory variables (input variable, independent variable) and information regarding the setting of the wireless communication for the learning target user terminal 40 is set as the objective variable (ground truth label, response variable, dependent variable).

In the case of performing supervised learning on the classification problem, the information processing apparatus 10 may perform machine learning using, for example, a neural network (NN), a decision tree, a support vector machine (SVM), or logistic regression.

In the case of performing supervised learning for the regression problem, the information processing apparatus 10 may perform machine learning using, for example, a neural network (NN), a recurrent neural network (RNN), a general regression neural network, a random forest, or linear regression such as a least squares method.

Subsequently, the generation unit 13 transmits (distributes) the generated trained model to the information processing apparatus 20 (step S105). As a result, the trained model is recorded (installed) in the information processing apparatus 20.

### Others

A case where machine learning is performed on the basis of the information recorded in the wireless communication DB 601 without performing the preprocessing in step S103 will be considered. In this case, for example, a value indicating the wireless state of each user terminal 40 and a value indicating the wireless state of each neighboring cell are also used as the explanatory variables. Here, due to the structure of a model such as a neural network, a learning result differs according to the order of data input at the time of learning.

For example, different trained models are generated between a case where the user terminal 40-1, the user terminal 40-2, . . . , and the user terminal 40-M are input to the neural network in this order and a case where the user terminals are input to the neural network in another order. Regarding the setting of the wireless communication for the learning target user terminal 40, it is considered that there is no particular meaning in an input order of the information of each user terminal 40. Therefore, the fact that the result of the machine learning differs according to the input order suggests that there is a possibility that the inference accuracy is relatively low, and it is considered that there is a possibility that appropriate wireless setting cannot be performed depending on the input order. In addition, since the number of pieces of input data at the time of performing the inference processing is a variable number (not a constant number), it is relatively difficult to handle with a normal machine learning model.

On the other hand, in the example embodiment of the present disclosure described above, since the addition value for each of one or more groups is input to the neural network or the like, it is possible to eliminate the occurrence of the difference in the calculation result caused by the difference in the input order as in the comparative example. Therefore, for example, the learning time can be shortened as compared with the case of learning for each input order. In addition, the inference time can be shortened as compared with a case where inference is performed using an average or the like of results inferred for each input order. In addition, it is possible to perform inference with relatively high accuracy with a model having a relatively small number of parameters. In addition, since the number of parameters can be reduced, the processing load of learning and inference can be reduced.

### Specifying Phase

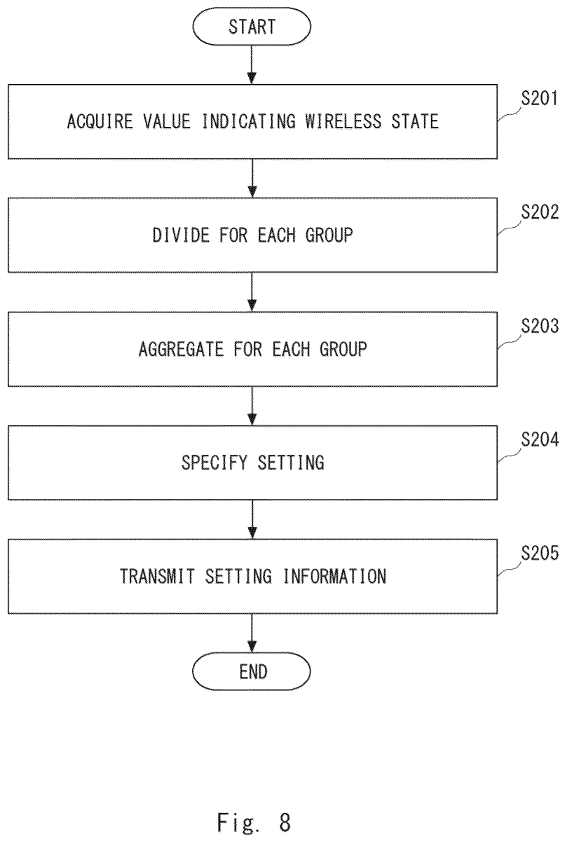

Next, an example of specifying processing of the information processing apparatus 20 according to the example embodiment will be described with reference to FIG. 8. FIG. 8 is a flowchart illustrating an example of specifying processing of the information processing apparatus 20 according to the example embodiment. The processing of FIG. 8 may be executed, for example, at a predetermined timing such as periodically (for example, every second) or at a timing when at least a part of the explanatory variables is changed. Hereinafter, an example of determining the setting of the wireless communication for the user terminal 40 (hereinafter, also appropriately referred to as “setting target user terminal 40”) located (position registration) in the base station 30-1 (serving cell) will be described. In addition, a case where the user terminals 40-1 to 40-K (note that K is a natural number smaller than M) exist in the base station 30-1 (position registration), and the base stations 30-2 to 30-L (note that L is a natural number smaller than N) are neighboring cells of the base station 30-1 will be described as an example. Note that the processing of FIG. 8 may be executed for each of the uplink and the downlink, for example. In addition, the processing of FIG. 8 may be executed for each user terminal 40 located in the serving cell, for example.

In step S201, the acquisition unit 21 acquires a value indicating the wireless state. The value indicating the wireless state may include a value indicating the wireless state of each of the plurality of user terminals 40 including the setting target user terminal 40, a value indicating the wireless state of each neighboring cell, and a value indicating the wireless state of the serving cell. The value indicating the wireless state may be information acquired (measured, calculated) at a certain time point by each base station 30.

Subsequently, the pre-processing unit 22 divides (classifies) the information acquired by the acquisition unit 21 for each group (step S202). Here, the pre-processing unit 22 may divide at least one of the user terminals 40 and the neighboring cells into groups by, for example, the processing similar to the processing in step S102 in FIG. 5.

In this case, for example, the pre-processing unit 22 may set a value group indicating the wireless state of each of the plurality of user terminals 40 as one group, or may divide the value group for each group of the user terminals 40. In addition, for example, the pre-processing unit 22 may set a value group indicating the wireless state of each neighboring cell as one group, or may divide the value group for each group of neighboring cells.

Subsequently, the pre-processing unit 22 of the information processing apparatus 20 performs preprocessing or the like of aggregating the values indicating the wireless states divided for each group, for each group (step S203). Here, for example, the pre-processing unit 22 may aggregate the divided data of each group by adding (for example, total) the divided data for each group by the processing similar to the processing of step S103 in FIG. 5.

The pre-processing unit 22 may set an addition value of values indicating the wireless states with a first granularity of the user terminals 40 included in the first group, as a value indicating the wireless state aggregated into the first group. In addition, the pre-processing unit 12 may set an addition value of values indicating the wireless states with a second granularity, which is coarser than the first granularity, of the user terminals included in the second group, as a value indicating the wireless state aggregated into the second group. In this case, the pre-processing unit 22 may set time-series data obtained by adding the value indicating the wireless state of each user terminal 40 included in the first group for each time point, as a value indicating the wireless state aggregated in the first group. In this case, for example, the pre-processing unit 22 may set the time-series data obtained by adding, for each time point, the value at each time point of the CQI of each user terminal 40 included in the first group or the value at each time point of the retransmission rate for each MCS, as the value indicating the wireless state aggregated into the first group. In addition, the pre-processing unit 22 may set the addition value of the average value of the values indicating the wireless states of the user terminals included in the second group, as a value indicating the wireless state aggregated into the second group. In this case, the pre-processing unit 22 may set the value obtained by adding the average value of the values at individual time points of the CQI of the user terminals 40 included in the second group or the value obtained by adding the average value of the values at individual time points of the retransmission rate for each MCS, as the value indicating the wireless state aggregated into the second group. As a result, the inference processing can be speeded up. Note that the wireless state of each user terminal 40 included in the second group may be acquired (measured) at intervals coarser than the wireless state of each user terminal 40 included in the first group.

Subsequently, the specifying unit 23 specifies (determines, infers, estimates, expects, predicts) the setting of the wireless communication for the setting target user terminal 40 on the basis of the data set for inference after preprocessing and the trained model generated in the processing of FIG. 5 by the information processing apparatus 10 (step S204).

Subsequently, the specifying unit 23 transmits information indicating the setting of the wireless communication for the specified setting target user terminal 40 to the base station 30-1 (step S205). Note that the base station 30-1 may perform the setting related to the wireless communication for the setting target user terminal 40 with respect to at least one of the setting target user terminal 40 and the base station 30-1 on the basis of the information received from the information processing apparatus 20.

### Example of Speeding Up Processing of Common Part

The information processing apparatus 20 may record an execution result of each processing after executing the processing from step S201 to step S203 in FIG. 8. Then, the processing from step S204 to step S205 in FIG. 8 may be executed for each of the user terminals 40-1 to 40-K which are the setting target user terminals 40. As a result, the processing can be speeded up as compared with the case where the processing from step S201 to step S205 in FIG. 8 is performed for each user terminal 40.

### MODIFIED EXAMPLE

Each of the information processing apparatus 10 and the information processing apparatus 20 may be an apparatus contained in one housing, but each of the information processing apparatus 10 and the information processing apparatus 20 of the present disclosure is not limited thereto. Each unit of the information processing apparatus 10 and the information processing apparatus 20 may be realized by, for example, cloud computing including one or more computers. In addition, at least a part of the information processing apparatus 10, the information processing apparatus 20, and the base station 30 may be realized by an integrated apparatus. Each of the information processing apparatus 10 and the information processing apparatus 20 as described above is also included in an example of the “information processing apparatus” of the present disclosure.

Note that the present disclosure is not limited to the above-described example embodiments, and can be appropriately modified without departing from the gist.

Some or all of the above-described example embodiments may be described as in the following Supplementary Notes, but are not limited to the following Supplementary Notes.

### Supplementary Note 1

An information processing apparatus including:
an acquisition unit configured to acquire a value indicating a wireless state with each of a plurality of user terminals located in a same base station;
a pre-processing unit configured to add the value indicating the wireless state of each user terminal acquired by the acquisition unit; and
a specifying unit configured to specify setting of wireless communication for a specific user terminal on the basis of an addition value calculated by the pre-processing unit and a value indicating the wireless state of the specific user terminal included in the plurality of user terminals acquired by the acquisition unit.

### Supplementary Note 2

The information processing apparatus according to Supplementary Note 1, in which the pre-processing unit is configured to specify a group to which each user terminal belongs on the basis of at least one of a communication requirement of each user terminal, a magnitude of wireless quality fluctuation, and a received radio field intensity, to calculate an addition value of a value indicating a wireless state with a first granularity of each user terminal included in a first group, and to calculate an addition value of a value indicating a wireless state with a second granularity, which is coarser than the first granularity, of each user terminal included in a second group.

### Supplementary Note 3

The information processing apparatus according to Supplementary Note 2, in which the pre-processing unit is configured to calculate at least one of time-series data obtained by adding a value at each time point of a channel quality indicator (CQI) of each user terminal included in the first group for each time point and time-series data obtained by adding a value at each time point of a retransmission rate for each modulation and coding scheme (MCS), and to calculate at least one of a value obtained by adding an average value of values at individual time points of the CQI of each user terminal included in the second group, and a value obtained by adding an average value of values at individual time points of the retransmission rate for each MCS.

### Supplementary Note 4

The information processing apparatus according to Supplementary Note 1 or 2, in which
the acquisition unit is configured to acquire a value indicating a wireless state of each of a plurality of neighboring cells of the base station, and
the pre-processing unit is configured to add the value indicating the wireless state of each neighboring cell acquired by the acquisition unit.

### Supplementary Note 5

The information processing apparatus according to Supplementary Note 4, in which the value indicating the wireless state of each of the plurality of neighboring cells includes information indicating a physical resource block (PRB) utilization rate in each neighboring cell.

### Supplementary Note 6

The information processing apparatus according to Supplementary Note 1 or 2, in which the specifying unit is configured to specify the setting of the wireless communication for the specific user terminal on the basis of at least one of a physical resource block (PRB) utilization rate in the base station and the number of user terminals in communication using the base station.

### Supplementary Note 7

The information processing apparatus according to Supplementary Note 1, in which the setting of the wireless communication for the specific user terminal includes at least one of a setting value of a modulation and coding scheme (MCS), a parameter of a scheduler of wireless communication, and setting of an upper limit of a spatial multiplexing number of multiple-input and multiple-output (MIMO).

### Supplementary Note 8

An information processing method of executing processing including:
acquiring a value indicating a wireless state with each of a plurality of user terminals located in a same base station;
adding the acquired value indicating the wireless state of each user terminal; and
specifying setting of wireless communication for a specific user terminal on the basis of an addition value and a value indicating the wireless state of the specific user terminal included in the plurality of user terminals.

### Supplementary Note 9

An information processing system including:
a specific user terminal; and an information processing apparatus,
in which the information processing apparatus includes
an acquisition unit configured to acquire a value indicating a wireless state with each of a plurality of user terminals located in a same base station,
a pre-processing unit configured to add the value indicating the wireless state of each user terminal acquired by the acquisition unit, and
a specifying unit configured to specify setting of wireless communication for the specific user terminal on the basis of an addition value calculated by the pre-processing unit and a value indicating the wireless state of the specific user terminal included in the plurality of user terminals acquired by the acquisition unit.

### Supplementary Note 10

The information processing system according to Supplementary Note 9, in which the pre-processing unit is configured to specify a group to which each user terminal belongs on the basis of at least one of a communication requirement of each user terminal, a magnitude of wireless quality fluctuation, and a received radio field intensity, to calculate time-series data obtained by adding a value indicating a wireless state of each user terminal included in a first group for each time point, and to calculate an addition value of an average value of values indicating a wireless state of each user terminal included in a second group.

### Supplementary Note 11

A non-transitory computer-readable medium in which a program of causing a computer to execute processing is stored, the processing including:
acquiring a value indicating a wireless state with each of a plurality of user terminals located in a same base station;
adding the acquired value indicating the wireless state of each user terminal; and
specifying setting of wireless communication for a specific user terminal on the basis of an addition value and a value indicating the wireless state of the specific user terminal included in the plurality of user terminals.

### Supplementary Note 12

An information processing apparatus including:
an acquisition unit configured to acquire a data set in which a value indicating a wireless state with each of a first plurality of user terminals located in a first base station is associated with information regarding setting of wireless communication for a first user terminal included in the first plurality of user terminals;
a pre-processing unit configured to add the value indicating the wireless state of each user terminal acquired by the acquisition unit; and
a generation unit configured to generate a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on the basis of the addition value calculated by the pre-processing unit, the value indicating the wireless state of the first user terminal acquired by the acquisition unit, and the information regarding the setting of the wireless communication for the first user terminal acquired by the acquisition unit.

### Supplementary Note 13

The information processing apparatus according to Supplementary Note 12, in which
the pre-processing unit is configured to specify a group to which each user terminal belongs on the basis of at least one of a communication requirement of each user terminal, a magnitude of wireless quality fluctuation, and a received radio field intensity, to calculate an addition value of a value indicating a wireless state with a first granularity of each user terminal included in a first group, and to calculate an addition value of a value indicating a wireless state with a second granularity, which is coarser than the first granularity, of each user terminal included in a second group, and
the generation unit is configured to generate the trained model for specifying the information regarding the setting of the wireless communication for the second user terminal, according to an addition value of a value indicating a wireless state of each user terminal included in the first group among the second plurality of user terminals, an addition value of a value indicating a wireless state with the first granularity of each user terminal included in the second group among the second plurality of user terminals, and a value indicating a wireless state with the second granularity of the second user terminal, on the basis of each addition value calculated by the pre-processing unit, the value indicating the wireless state of the first user terminal acquired by the acquisition unit, and the information regarding the setting of the wireless communication for the first user terminal acquired by the acquisition unit.

### Supplementary Note 14

The information processing apparatus according to Supplementary Note 13, in which the pre-processing unit is configured to calculate at least one of time-series data obtained by adding a value at each time point of a channel quality indicator (CQI) of each user terminal included in the first group for each time point and time-series data obtained by adding a value at each time point of a retransmission rate for each modulation and coding scheme (MCS), and to calculate at least one of a value obtained by adding an average value of values at individual time points of the CQI of each user terminal included in the second group, and a value obtained by adding an average value of values at individual time points of the retransmission rate for each MCS.

### Supplementary Note 15

The information processing apparatus according to Supplementary Note 12 or 13, in which
the acquisition unit is configured to acquire a value indicating a wireless state of each of a plurality of neighboring cells of the first base station,
the pre-processing unit is configured to add the value indicating the wireless state of each neighboring cell acquired by the acquisition unit, and
the generation unit is configured to generate the trained model for specifying the information regarding the setting of the wireless communication for the second user terminal, according to each of one or more addition values of a value indicating a wireless state for the second plurality of user terminals, an addition value of a value indicating a wireless state of each of a plurality of neighboring cells of the second base station, and a value indicating a wireless state of the second user terminal, on the basis of each addition value calculated by the pre-processing unit, the value indicating the wireless state of the first user terminal acquired by the acquisition unit, and the information regarding the setting of the wireless communication for the first user terminal acquired by the acquisition unit.

### Supplementary Note 16

The information processing apparatus according to Supplementary Note 15, in which the value indicating the wireless state of each of the plurality of neighboring cells includes information indicating a physical resource block (PRB) utilization rate in each neighboring cell.

### Supplementary Note 17

The information processing apparatus according to Supplementary Note 12 or 13, in which the generation unit is configured to generate the trained model on the basis of at least one of a physical resource block (PRB) utilization rate in the first base station and the number of user terminals in communication using the first base station.

### Supplementary Note 18

The information processing apparatus according to Supplementary Note 12, in which the setting of the wireless communication for the first user terminal includes at least one of a setting value of a modulation and coding scheme (MCS), a parameter of a scheduler of wireless communication, and setting of an upper limit of a spatial multiplexing number of multiple-input and multiple-output (MIMO).

### Supplementary Note 19

A generation method including:
acquiring a data set in which a value indicating a wireless state with each of a first plurality of user terminals located in a first base station is associated with information regarding setting of wireless communication for a first user terminal included in the first plurality of user terminals;
adding the acquired value indicating the wireless state of each user terminal; and
generating a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on the basis of the addition value, the value indicating the wireless state of the first user terminal, and the information regarding the setting of the wireless communication for the first user terminal.

### Supplementary Note 20

A non-transitory computer-readable medium in which a program of causing a computer to execute processing is stored, the processing including:
acquiring a data set in which a value indicating a wireless state with each of a first plurality of user terminals located in a first base station is associated with information regarding setting of wireless communication for a first user terminal included in the first plurality of user terminals;
adding the acquired value indicating the wireless state of each user terminal; and
generating a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on the basis of the addition value, the value indicating the wireless state of the first user terminal, and the information regarding the setting of the wireless communication for the first user terminal.

### REFERENCE SIGNS LIST

1 INFORMATION PROCESSING SYSTEM
10 INFORMATION PROCESSING APPARATUS
11 ACQUISITION UNIT
12 PRE-PROCESSING UNIT
13 GENERATION UNIT
20 INFORMATION PROCESSING APPARATUS
21 ACQUISITION UNIT
22 PRE-PROCESSING UNIT
23 SPECIFYING UNIT
30 BASE STATION
40 USER TERMINAL

What is claimed is:

1. An information processing method of executing processing comprising:
acquiring a value indicating a wireless state with each of a plurality of user terminals located in a same base station;
adding the acquired value indicating the wireless state of each user terminal; and
specifying setting of wireless communication for a specific user terminal on a basis of an addition value and a value indicating the wireless state of the specific user terminal included in the plurality of user terminals.

2. The information processing method according to claim 1, wherein adding the acquired value indicating the wireless state of each user terminal comprises:
specifying a group to which each user terminal belongs on a basis of at least one of a communication requirement of each user terminal, a magnitude of wireless quality fluctuation, and a received radio field intensity,
calculating an addition value of a value indicating a wireless state with a first granularity of each user terminal included in a first group, and
calculating an addition value of a value indicating a wireless state with a second granularity, which is coarser than the first granularity, of each user terminal included in a second group.

3. The information processing method according to claim 2, wherein adding the acquired value indicating the wireless state of each user terminal comprises:
calculating at least one of time-series data obtained by adding a value at each time point of a channel quality indicator (CQI) of each user terminal included in the first group for each time point and time-series data obtained by adding a value at each time point of a retransmission rate for each modulation and coding scheme (MCS), and to calculate at least one of a value obtained by adding an average value of values at individual time points of the CQI of each user terminal included in the second group, and a value obtained by adding an average value of values at individual time points of the retransmission rate for each MCS.

4. The information processing method according to claim 1, comprising:
acquiring a value indicating a wireless state of each of a plurality of neighboring cells of the base station, and
adding the value indicating the wireless state of each neighboring cell acquired by the acquisition unit.

5. The information processing method according to claim 4, wherein the value indicating the wireless state of each of the plurality of neighboring cells includes information indicating a physical resource block (PRB) utilization rate in each neighboring cell.

6. The information processing method according to claim 1, wherein specifying setting of wireless communication for a specific user terminal comprises:
specifying the setting of the wireless communication for the specific user terminal on a basis of at least one of a physical resource block (PRB) utilization rate in the base station and the number of user terminals in communication using the base station.

7. The information processing method according to claim 1, wherein the setting of the wireless communication for the specific user terminal includes at least one of a setting value of a modulation and coding scheme (MCS), a parameter of a scheduler of wireless communication, and setting of an upper limit of a spatial multiplexing number of multiple-input and multiple-output (MIMO).

8-11. (canceled)

12. A generation method comprising:
acquiring a data set in which a value indicating a wireless state with each of a first plurality of user terminals located in a first base station is associated with information regarding setting of wireless communication for a first user terminal included in the first plurality of user terminals;
adding the acquired value indicating the wireless state of each user terminal; and
generating a trained model for specifying information regarding setting of wireless communication for a second user terminal, according to an addition value of a value indicating a wireless state with each of a second plurality of user terminals located in a second base station and a value indicating a wireless state of the second user terminal included in the second plurality of user terminals, on a basis of the addition value, the value indicating the wireless state of the first user terminal, and the information regarding the setting of the wireless communication for the first user terminal.

13. The generation method according to claim 12, wherein
adding the acquired value indicating the wireless state of each user terminal comprises:
specifying a group to which each user terminal belongs on a basis of at least one of a communication requirement of each user terminal, a magnitude of wireless quality fluctuation, and a received radio field intensity,
calculating an addition value of a value indicating a wireless state with a first granularity of each user terminal included in a first group, and
calculating an addition value of a value indicating a wireless state with a second granularity, which is coarser than the first granularity, of each user terminal included in a second group, and
generating the trained model comprises:
generating the trained model for specifying the information regarding the setting of the wireless communication for the second user terminal, according to an addition value of a value indicating a wireless state of each user terminal included in the first group among the second plurality of user terminals, an addition value of a value indicating a wireless state with the first granularity of each user terminal included in the second group among the second plurality of user terminals, and a value indicating a wireless state with the second granularity of the second user terminal, on a basis of each addition value, the value indicating the wireless state of the first user terminal, and the information regarding the setting of the wireless communication for the first user terminal.

14. The generation method according to claim 13, wherein adding the acquired value indicating the wireless state of each user terminal comprises:
calculating at least one of time-series data obtained by adding a value at each time point of a channel quality indicator (CQI) of each user terminal included in the first group for each time point and time-series data obtained by adding a value at each time point of a retransmission rate for each modulation and coding scheme (MCS), and
calculating at least one of a value obtained by adding an average value of values at individual time points of the CQI of each user terminal included in the second group, and a value obtained by adding an average value of values at individual time points of the retransmission rate for each MCS.

15. The generation method according to claim 12, comprises:
acquiring a value indicating a wireless state of each of a plurality of neighboring cells of the first base station,
adding the value indicating the wireless state of each neighboring cell, and
generating the trained model for specifying the information regarding the setting of the wireless communication for the second user terminal, according to each of one or more addition values of a value indicating a wireless state for the second plurality of user terminals, an addition value of a value indicating a wireless state of each of a plurality of neighboring cells of the second base station, and a value indicating a wireless state of the second user terminal, on a basis of each addition value, the value indicating the wireless state of the first user terminal, and the information regarding the setting of the wireless communication for the first user terminal.

16. The generation method according to claim 15, wherein the value indicating the wireless state of each of the plurality of neighboring cells includes information indicating a physical resource block (PRB) utilization rate in each neighboring cell.

17. The generation method according to claim 12, wherein generating the trained model comprises:
generating the trained model on a basis of at least one of a physical resource block (PRB) utilization rate in the first base station and the number of user terminals in communication using the first base station.

18. The generation method according to claim 12, wherein the setting of the wireless communication for the first user terminal includes at least one of a setting value of a modulation and coding scheme (MCS), a parameter of a scheduler of wireless communication, and setting of an upper limit of a spatial multiplexing number of multiple-input and multiple-output (MIMO).

19-20. (canceled)
